(19) United States
(12) Patent Application Publication
(10) Pub. No.: US 2010/0169080 A1
(43) Pub. Date: Jul. 1, 2010

(54) AUDIO ENCODING APPARATUS

(75) Inventors: Yoshiteru Tsuchinaga, Fukuoka (JP); Miyuki Shirakawa, Fukuoka (JP); Masanao Suzuki, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/634,862

(22) Filed: Dec. 10, 2009

(30) Foreign Application Priority Data
Dec. 26, 2008 (JP) 2008-335027

(51) Int. Cl. G10L 19/00; G10L 21/00

(52) U.S. Cl. 704/200.1; 704/229; 704/500; 704/500; 375/240; 704/E19.001; 704/E21.001

(57) ABSTRACT

An audio encoding apparatus that encodes audio signals of a plurality of channels, includes an adaptive bit allocation control unit that adaptively controls a number of encoding bits assigned to the audio signal of each channel in accordance with perceptual entropy of the audio signal of each of the channels,
a fixed bit allocation control unit that fixedly controls the number of encoding bits assigned to the audio signal of each of the channels in predetermined allocations, and a channel encoding unit that encodes the audio signal of each of the channels based on the number of adaptive allocation bits assigned by the adaptive bit allocation control unit and the number of fixed allocation bits assigned by the fixed bit allocation control unit.

### CROSS-REFERENCE TO RELATED APPLICATIONS

This application is based upon and claims the benefit of priority of the prior Japanese Patent Application No. 2008-335027, filed on Dec. 26, 2008, the entire contents of which are incorporated herein by reference.

### FIELD

The technology to be disclosed relates to an audio encoding technology used in a storage media field such as silicon audio and DVD or in a broadcasting field such as digital broadcasting. The technology to be disclosed can be used in a sound processing unit or the like of a content conversion apparatus or video IP transmission apparatus.

### BACKGROUND

With the transition from analog broadcasting to digital broadcasting, migration to broadband of wire and wireless networks, and higher performance of terminals, a technology to encode audio and video in high quality when communication resources are limited is needed.

In a video delivery service of the Internet, digital broadcasting and the like, among others, content of 5.1-channel audio superior in ambience to conventional stereo is on the increase and audio encoding technology capable of compressing 5.1-channel audio in high sound quality is growing in demand.

The International Organization for Standardization ISO/IEC (International Organization for Standardization/International Electrotechnical Commission) has standardized MPEG-2 AAC (hereinafter, referred to as “AAC”) as an audio encoding method compliant with 5.1-channel audio in MPEG (Moving Picture Experts Group), which is a multimedia specialist group. AAC is adopted, for example, in terrestrial/satellite/IP digital broadcasting standards in Japan. However, ISO/IEC has standardized only the decoding method as the data format of AAC and has standardized no encoding method. Thus, a higher-quality sound encoding method is desired.

The 5.1-channel audio is adopted also for movies and DVD. In the 5.1-channel audio, as illustrated in FIG. 13B, reproduction is performed by a total of six channels, three front channels (center, left, and right), two rear channels (surround left and right), and one channel (denoted as a 0.1 channel) for low-frequency effects. Thus, the 5.1-channel audio is superior to conventional stereo in spread of sound and expressiveness of bass sound.

Generally, as illustrated in FIG. 13A, an encoder 1301 encodes a multi-channel input signal to generate a compressed code, which is encoded data. The compressed code has, for example, 320 kbps illustrated in FIG. 13A, a constant transmission speed. After being transmitted to a communication path, the compressed code is received by a terminal apparatus. Then, the compressed code is decoded by a decoder 1302 to reproduce the multi-channel signal. At this point, quality of received sound depends greatly on how the encoder 1301 generates a compressed code of constant transmission speed by performing efficient encoding.

In digital broadcasting in Japan, for example, realization of sound quality close to the original sound is demanded at a low bit rate of about 320 kbps for 5.1-channel audio. That is, the amount of information per channel decreases. Thus, if the amount of information for each channel is set to a fixed value, sound quality deteriorates in a channel that needs a large amount of information for encoding and conversely the amount of information is wasted in a channel that needs a smaller amount of information. Therefore, a technology that decides the amount of information for each channel depending on properties of an input signal is needed.

In the face of such subjects, a conventional technology that calculates a physical quantity called perceptual entropy (or complexity) of an input sound in consideration of psychoacoustic characteristics and decides the amount of information of each channel based on the perceptual entropy is known.

FIG. 14 is a diagram illustrating the configuration of the conventional technology and FIG. 15 is an operation flow chart showing the operation thereof.

A PE value calculation unit 1401 calculates perceptual entropy values PE(1) to PE(N) of each channel signal from a multi-channel input signal ranging from a Channel 1 signal to a Channel N signal (step S1501 in FIG. 15).

A bit allocation control unit 1402 decides bit assignments Bit(1) to Bit(N) in #1 to #N channel encoding units 1403 in accordance with the perceptual entropy values PE(1) to PE(N) of each channel signal (step S1502 in FIG. 15).

#1 to #N channel encoding units 1403 encode the Channel 1 signal to the Channel N signal with the assigned bit assignments Bit(1) to Bit(N), respectively (steps S1503 (#1) to S1503 (#N) in FIG. 15).

A multiplexing unit 1404 multiplexes compressed codes of each channel output from the #1 to #N channel encoding units 1403 and outputs a resultant bit stream to a transmission path (step S1504 in FIG. 15).

The perceptual entropy (PE) is a physical quantity, as illustrated in FIG. 16A, representing an energy difference between masking power, which is an energy level of sound contained in an input audio signal and inaudible to human ears, and input signal power of the audio signal. Masking power is known to correspond to a allowed quantization error when a signal is encoded. The PE value tends, as exemplified in FIG. 16B, to increase in an interval in which an attack sound whose signal level changes abruptly like a percussion instrument sound is present. That is, a difference between input signal power and masking power=allowed quantization error increases in an interval having a large PE value, which shows that an increased amount of information is needed.

Thus, according to the conventional technology illustrated in FIG. 14, sound quality is improved without changing the total amount of information by judging that it is necessary to allocate an increased amount of information to a channel having a larger PE value and accordingly allocating an increased amount of information for encoding and allocating a decreased amount of information to a channel having a smaller PE value.

FIG. 17 is an explanatory view of operation of bit allocation control performed by the bit allocation control unit 1402 according to the conventional technology illustrated in FIG. 14. FIG. 17 illustrates an example of a 3-channel input signal for the sake of simplicity of description. Assume that the number of available bits in the whole multi-channel is 1000 bits per frame. Assume also that the perceptual entropy values PE(1), PE(2), and PE(3) of each channel signal are 30, 50, and 20, respectively. As a result, the bit assignments Bit(1) to Bit(N)=Bit(3) in the #1 to #N=#3 channel encoding units 1403 illustrated in FIG. 14 are decided in the ratio of the PE values, resulting in 300 bits, 500 bits, and 200 bits, respectively.

Regarding the conventional technology, Japanese Patent Application National Publication (Laid-Open) No. 2004-514180, Japanese Patent Application Laid-Open (JP-A) No. 2001-343997, JP-A No. 2004-21153, and JP-A No. 2001-77698 are disclosed.

### SUMMARY

According to an aspect of the invention, an audio encoding apparatus that encodes audio signals of a plurality of channels, includes an adaptive bit allocation control unit that adaptively controls a number of encoding bits assigned to the audio signal of each channel in accordance with perceptual entropy of the audio signal of each of the channels, a fixed bit allocation control unit that fixedly controls the number of encoding bits assigned to the audio signal of each of the channels in predetermined allocations, and a channel encoding unit that encodes the audio signal of each of the channels based on the number of adaptive allocation bits assigned by the adaptive bit allocation control unit and the number of fixed allocation bits assigned by the fixed bit allocation control unit.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a first embodiment.

FIG. 2 is an operation flow chart showing an operation of the first embodiment.

FIG. 3 is an explanatory view of an effect of bit allocation control in the first embodiment.

FIG. 4 is an explanatory view of the operation of bit allocation control in the first embodiment.

FIG. 5 is an operation flow chart showing the operations of bit replenishing control realized by a bit reservoir 106 and a channel bit reservoir 107.

FIG. 6 is an explanatory view of the operation of bit replenishing control realized by the bit reservoir 106 and the channel bit reservoir 107.

FIG. 7 is a diagram illustrating an effect of improvement in sound quality according to the first embodiment.

FIG. 8 is a schematic diagram of a second embodiment.

FIG. 9 is a schematic diagram of a third embodiment.

FIG. 10 is a relational diagram of bit allocation.

FIG. 11 is a diagram illustrating the configuration of a channel encoding unit 105.

FIG. 12 is an operation flow chart showing the operation of bit replenishing control realized by the bit reservoir 106 and the channel bit reservoir 107.

FIGS. 13A and 13B are explanatory views of encoding/decoding of 5.1-channel audio.

FIG. 14 is a schematic diagram of a conventional technology that decides the amount of information of each channel based on perceptual entropy.

FIG. 15 is an operation flow chart of the conventional technology that decides the amount of information of each channel based on perceptual entropy.

FIGS. 16A and 16B are explanatory views of the perceptual entropy.

FIG. 17 is an explanatory view of the operation of bit allocation control according to the conventional technology.

FIG. 18 is an explanatory view of a problem of the conventional technology.

### DESCRIPTION OF EMBODIMENTS

According to the conventional bit allocation control technology using perceptual entropy, an estimation error occurs between the number of bits estimated based on the PE values and the number of actually necessary bits.

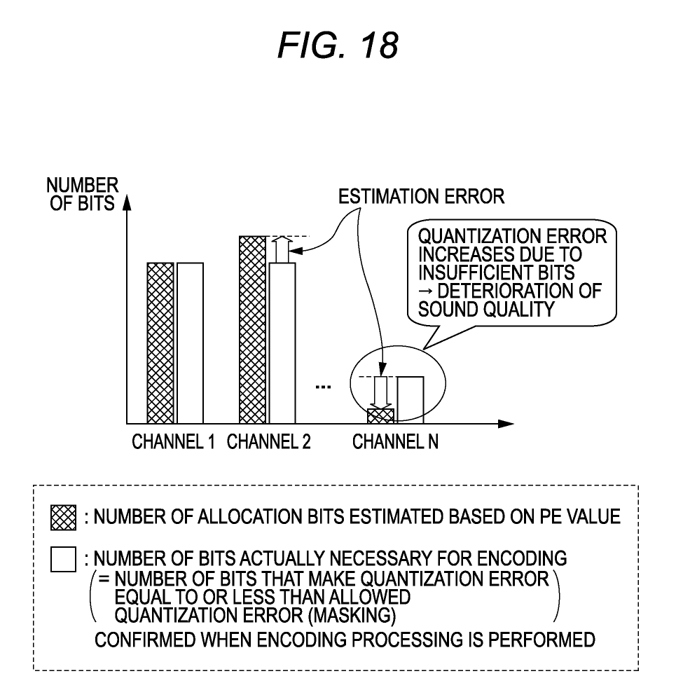

For example, as illustrated in FIG. 18, the number of allocation bits estimated based on the PE value is greater than the number of bits necessary for actual encoding (=number of bits to make a quantization error equal to or less than a allowed quantization error (masking power)) in Channel 2. In contrast, the number of bits necessary for actual encoding is greater than the number of allocation bits estimated based on the PE value in Channel N. In this case, while too many bits are allocated to Channel 2, a quantization error increases in Channel N due to insufficient bits, leading to degraded sound quality.

This trend is particularly obvious under low bit rate conditions (the number of available bits is small) and there is a problem that deterioration is more easily perceived depending on the position of a degraded channel.

Subjects to be solved by the disclosed invention lie in suppressing an increase of a quantized error due to insufficient bits.

A mode of the disclosed invention assumes an audio encoding apparatus or method that encodes audio signals of a plurality of channels.

An adaptive bit allocation control unit adaptively controls the number of encoding bits allocated to an audio signal of each channel in accordance with perceptual entropy of the audio signal of each channel.

A fixed bit allocation control unit fixedly controls the number of encoding bits allocated to an audio signal of each channel in accordance with predetermined allocation.

A channel encoding unit encodes an audio signal of each channel based on the number of adaptive allocation bits allocated by the adaptive bit allocation control unit and the number of fixed allocation bits allocated by the fixed bit allocation control unit.

According to the disclosed invention, (constantly) available bits can fixedly be guaranteed by using fixed bit allocation control that is not dependent on an input signal, in addition to adaptive bit allocation control that is dependent on an input signal, when a multi-channel input signal such as a 5.1-channel audio signal is encoded.

If bits are still insufficient after adaptive bit allocation and fixed bit allocation, insufficient bit can be replenished by a bit reservoir unit and conversely excessive bits can be appropriated to subsequent encoding by storing such bits in the bit reservoir unit.

Thus, when compared with the conventional adaptive bit allocation based on the perceptual entropy value only, optimal bit allocation for a multi-channel input signal can be achieved while suppressing bit shortages caused by an estimation error so that stable sound quality can be realized.

The embodiments will be described below in detail.

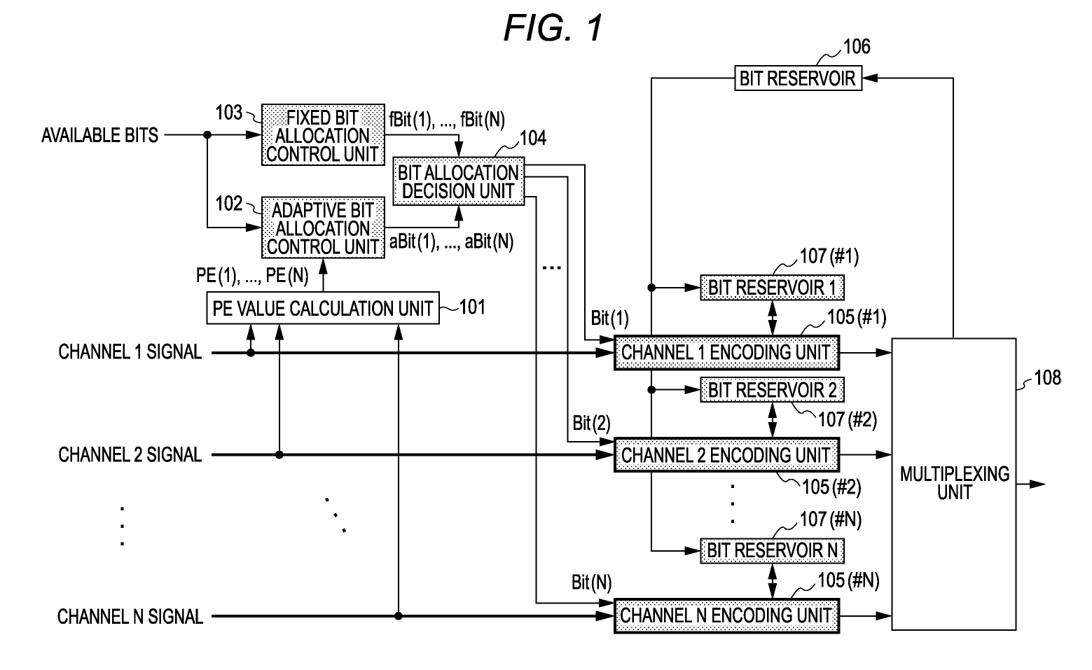

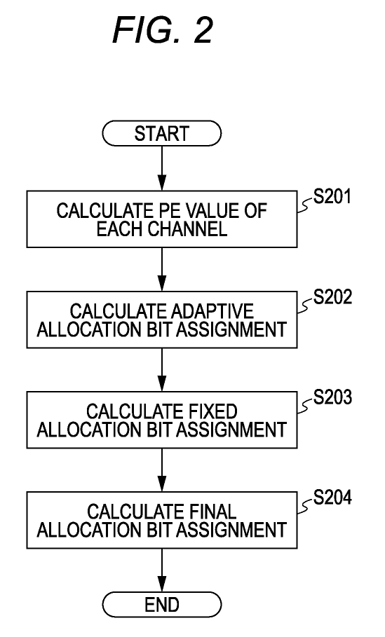

FIG. 1 is a schematic diagram of the first embodiment and FIG. 2 is an operation flow chart illustrating the operation thereof.

A PE value calculation unit 101 calculates perceptual entropy values PE(1) to PE(N) of each channel signal from a multi-channel input signal ranging from a Channel 1 signal to a Channel N signal (step S201 in FIG. 2).

An adaptive bit allocation control unit 102 decides adaptive allocation bit assignments aBit(1) to aBit(N) in accordance with the perceptual entropy values PE(1) to PE(N) of each channel signal (step S202 in FIG. 2).

A fixed bit allocation control unit 103 decides fixed allocation bit assignments fBit(1) to fBit(N) based on a preset fixed allocation ratio (step S203 in FIG. 2)

A bit allocation decision unit 104 decides final allocation bit assignments Bit(1) to Bit(N) in the #1 to #N channel encoding units 105 by integrating the adaptive allocation bit assignments and fixed allocation bit assignments (step S204 in FIG. 2).

On the other hand, #1 to #N channel bit reservoirs 107 compensate for insufficient bits in the #1 to #N channel encoding units 105. The bit reservoir 106 supplies excessive bits to the channel bit reservoirs 107 based on a generation result of a bit stream by a multiplexing unit 108. Further concrete operations of the bit reservoir 106 and the channel bit reservoirs 107 will be described later.

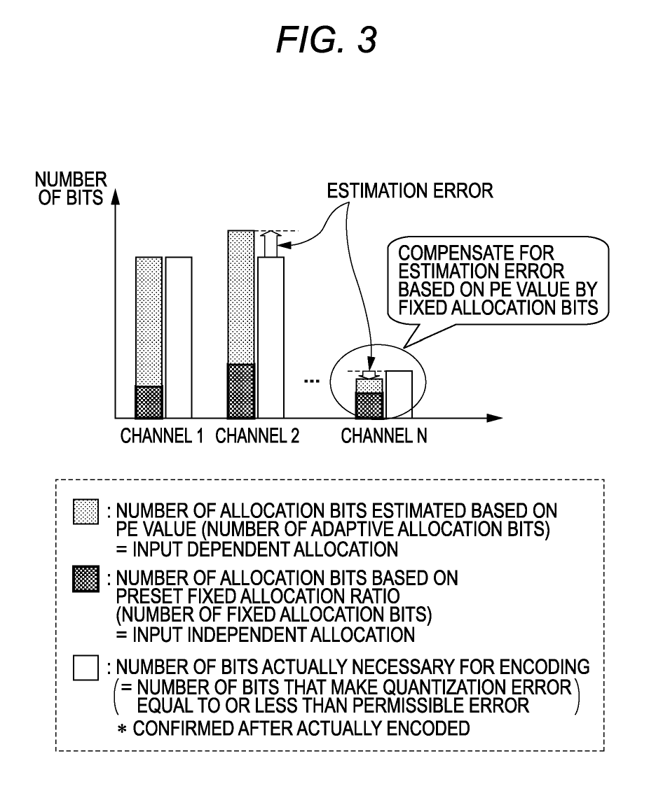

FIG. 3 is an explanatory view of an effect of bit allocation control in the first embodiment.

In the first embodiment, the number of fixed allocation bits based on the fixed allocation ratio preset for each channel is used in combination with the number of adaptive allocation bits estimated based on the PE values. While the former is not dependent on a multi-channel input signal, the latter is dependent on an input signal.

Thus, in the first embodiment, fixedly constantly available bits are guaranteed for each channel independent of input. Accordingly, an estimation error based on the PE values is compensated for.

The fixed allocation ratio in this case can be decided based on the degree of influence of channel arrangement on subjective sound quality. This is a parameter that is not dependent on input signal variations.

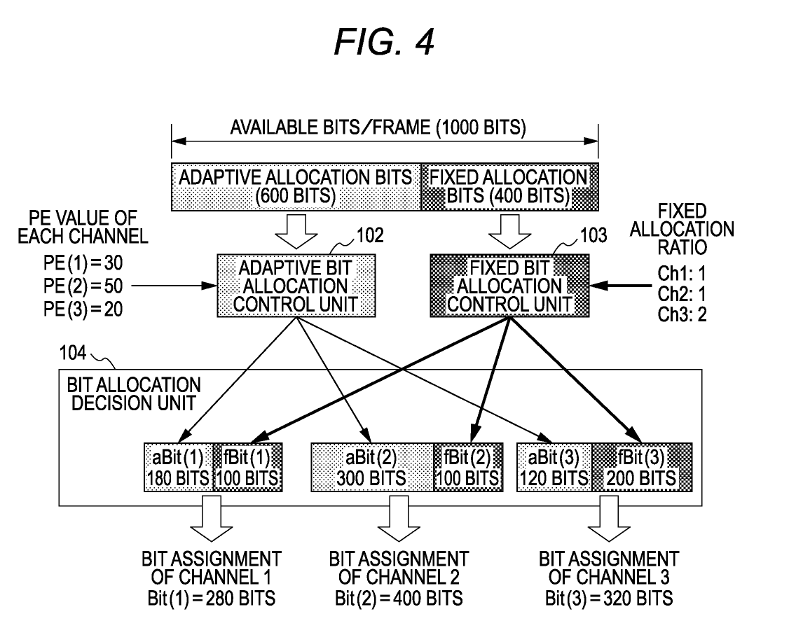

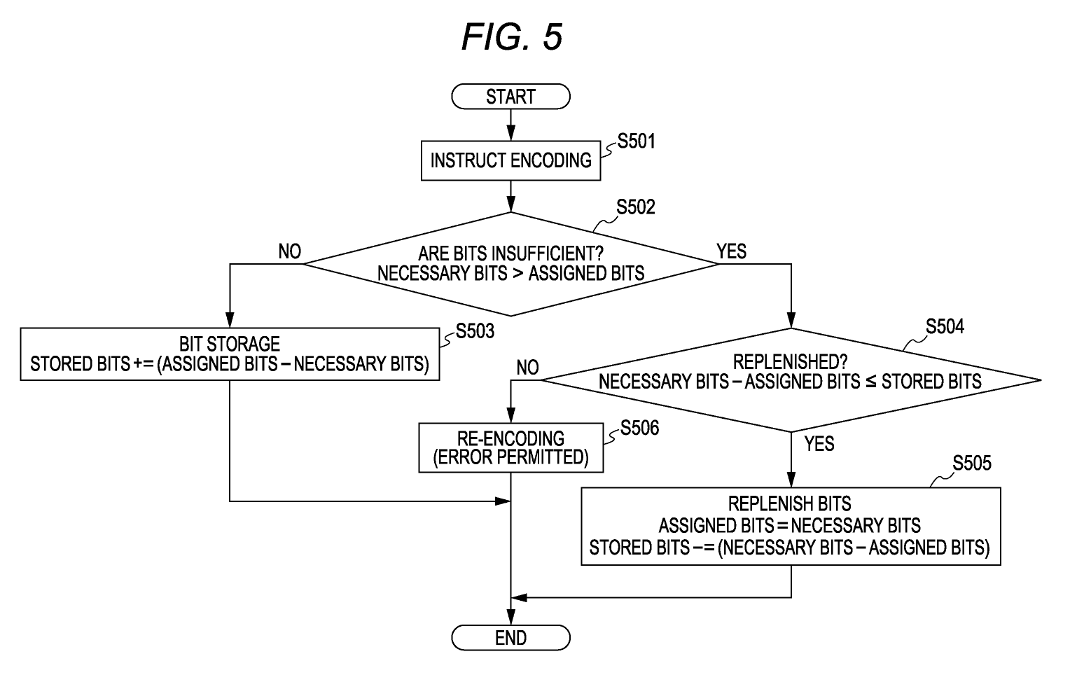

FIG. 4 is an explanatory view of the operation of bit allocation control in the first embodiment and FIG. 5 is an operation flow chart showing the operation thereof. FIG. 4 illustrates an example of a 3-channel input signal for the sake of simplicity of description.

Assume that the number of available bits in the whole multi-channel is 1000 bits per frame. Assume also that 600 bits are assigned as adaptive allocation bits and 400 bits are assigned as fixed allocation bits.

Now, assume that the perceptual entropy values PE(1), PE(2), and PE(3) of each channel signal are 30, 50, and 20, respectively. As a result, the adaptive allocation bit assignments aBit(1) to aBit(3) decided by the adaptive bit allocation control unit 102 are decided in a ratio of each of the PE values from 600 bits as adaptive allocation bits, resulting in 180 bits, 300 bits, and 120 bits, respectively.

On the other hand, the fixed allocation bit assignments fBit(1) to fBit(N) decided by the fixed bit allocation control unit 103 are decided in a fixed allocation ratio “Channel 1=1:Channel 2=1:Channel 3=2” preset for each channel, resulting in 100 bits, 100 bits, and 200 bits, respectively.

As a result, the bit assignments Bit(1) to Bit(3) in the #1 to #3 channel encoding units 105 decided by the bit allocation decision unit 104 in the end are calculated by the adaptive allocation bit assignment and fixed allocation bit assignment for each channel being added. That is, the bit assignments Bit(1) to Bit(3) in the #1 to #3 channel encoding units 105 will be 280 bits, 400 bits, and 320 bits, respectively.

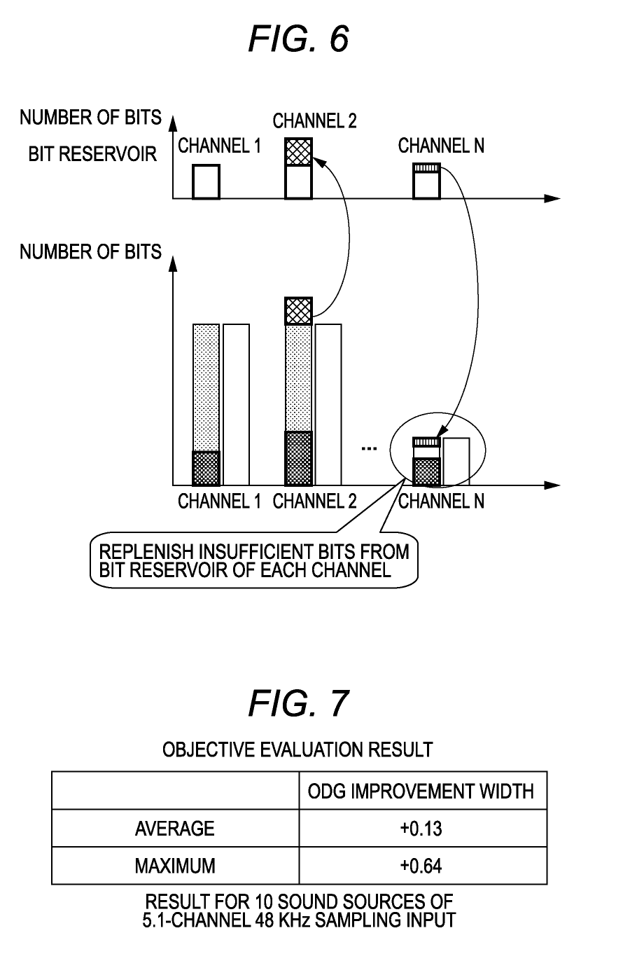

FIG. 5 is an operation flow chart showing the operation of bit replenishing control realized by the bit reservoir 106 and the channel bit reservoir 107 in FIG. 1 and FIG. 6 is an explanatory view of the operation thereof.

First, the bit reservoir 106 adds and reserves bits stored in the #1 to #N channel bit reservoirs 107 prior to the previous frame from a bit stream output from the multiplexing unit 108. Then, the bit reservoir 106 allocates the added reserve bits to the #1 to #N channel bit reservoirs 107 as storage bits for each channel using the preset allocation ratio in the current frame.

The #1 to #N channel bit reservoirs 107 and the bit reservoir 106 execute the operation illustrated in the operation flow chart in FIG. 5.

First, the #1 to #N channel bit reservoirs 107 instruct the #1 to #N channel encoding units 105 to perform encoding, respectively (step S501 in FIG. 5). As a result, the #1 to #N channel encoding units 105 encode each input signal of the Channel 1 signal to Channel N signal using the bit assignments Bit(1) to Bit(N) allocated by the bit allocation decision unit 104, respectively. As an encoding method in this case, for example, the AAC method is adopted.

Next, the #1 to #N channel bit reservoirs 107 determine whether the number of bits necessary for encoding is larger than the assigned bits in the #1 to #N channel encoding units 105, respectively, that is, whether a bit shortage has occurred (step S502 in FIG. 5).

The channel bit reservoir 107 in which no bit shortage occurs and whose determination at step S502 is NO notifies excessive bits (=assigned bits−necessary bits) to the bit reservoir 106. As a result, the bit reservoir 106 adds the excessive bits to storage bits to terminate processing on the channel in the current frame (step S503 in FIG. 5).

On the other hand, the channel bit reservoir 107 in which a bit shortage occurs and whose determination at step S502 is YES determines whether insufficient bits can be replenished. That is, the channel bit reservoir 107 determines whether (necessary bits−assigned bits) is equal to or less than storage bits of the channel bit reservoir 107 (step S504 in FIG. 5).

If bits can be replenished and the determination of the channel bit reservoir 107 at step S504 is YES, assigned bits of the channel bit reservoir 107 are set to necessary bits and replenished bits (=necessary bits−assigned bits) are subtracted from storage bits to set the new value of storage bits of the channel (step S505 in FIG. 5). Accordingly, encoding will be performed in the channel encoding unit 105 corresponding to the channel bit reservoir 107 using newly assigned bits.

On the other hand, if bits cannot be replenished and the determination at step S504 is NO, the number of quantization steps for the channel encoding unit 105 corresponding to the channel bit reservoir 107 is changed in such away that necessary bits that become necessary as a result of quantization is equal to or less than assigned bits and encoding permitting an quantization error is instructed again (step S506 in FIG. 5).

With the bit reserve control, as illustrated in FIG. 6, insufficient bits even after bit allocation by the fixed bit allocation control unit 103, the adaptive bit allocation control unit 102, and the bit allocation decision unit 104 can be replenished from each of the channel bit reservoirs 107.

FIG. 7 is a diagram illustrating an effect of improvement in sound quality according to the first embodiment. The result is obtained from 10 kinds of input sound sources of 5.1-channel 48 KHz sampling. According to the first embodiment, improvement of up to +0.5 points or more depending on the sound source in the ODG value, +0.13 points on average, was achieved. Accordingly, overall performance improvements with respect to various sound sources can be expected. Also, local deterioration of sound quality was subjectively suppressed and so that stable sound quality was obtained. ODG (Objective Difference Grade) is a measured value conforming to the PEAQ (Perceptual Evaluation of Audio Quality) method specified by the recommendation BS.1387-1 of the international standard ITU-R. According to this measurement method, error distortion (=sound quality) caused by encoding of a decoded signal with respect to the original signal is measured objectively based on psychoacoustic characteristics and an ODG value of the 0 to 4 value is output. The ODG value closer to 0 indicates better sound quality.

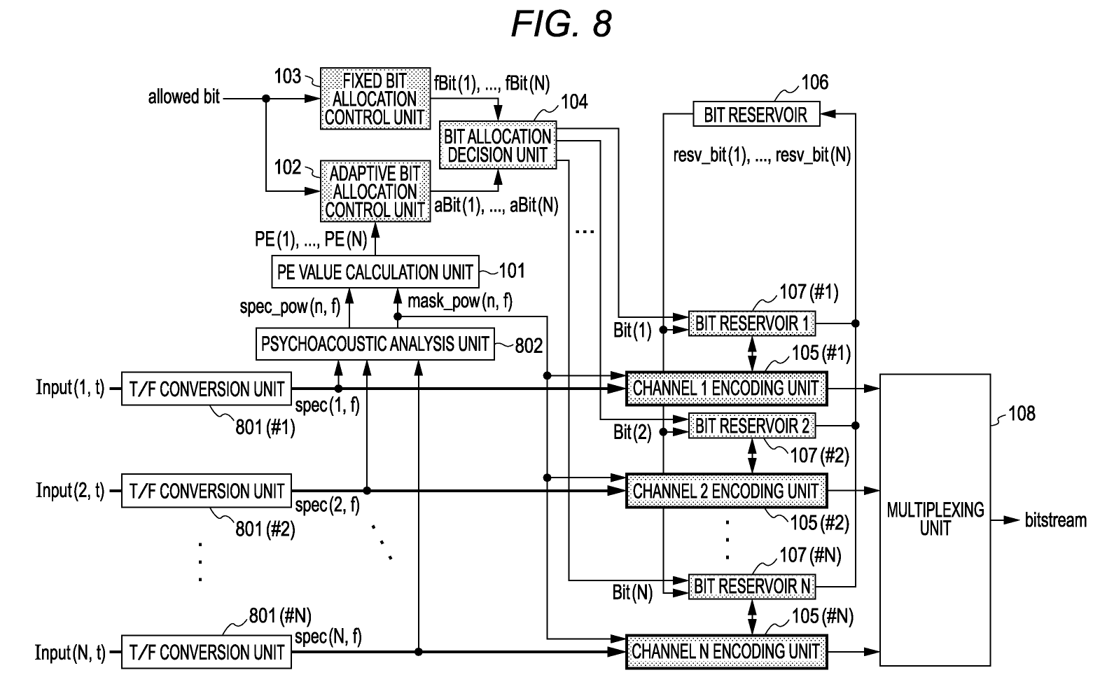

FIG. 8 is a schematic diagram of a second embodiment. This configuration is obtained by further making the configuration of the first embodiment illustrated in FIG. 1 in more detail. In FIG. 8, the same number is attached to the same component as that in FIG. 1.

In FIG. 8, T/F conversion units 801 convert a signal Input (n, t) obtained by dividing an input signal into frames into a frequency domain (=frequency spectrum) signal spec (n, f), where n is a channel (n=1 to N), t is a time sample (t=0 to T), and f is a frequency sample (f=0 to F).

An psychoacoustic analysis unit 802 calculates spectral power spec_pow (n, f) from the frequency domain signal spec (n, f) output from the T/F conversion units 801. The psychoacoustic analysis unit 802 also calculates masking power mask_pow (n, f), which is a power value not perceived by human ears, from the spectral power spec_pow (n, f) based on human psychoacoustic characteristics for each frequency sample. Then, the psychoacoustic analysis unit 802 outputs the calculated spectral power spec_pow (n, f) and masking power mask_pow (n, f) to the PE value calculation unit 101.

The PE value calculation unit 101 calculates perceptual entropy values PE(1) to PE(N) of each channel signal from the spectral power spec_pow (n, f) and masking power mask_pow (n, f) of each channel. For example, the method released as C.1 Psychoacoustic Model of Annex C (Encoder) of MPEG-2 AAC ISO/IEC 13818-7: 2006 (E), which is an international standard, can be used for calculation processing of PE values.

Operations of the adaptive bit allocation control unit 102, the fixed bit allocation control unit 103, and the bit allocation decision unit 104 are the same as those in the first embodiment illustrated in FIG. 1.

Operations of the channel encoding unit 105, the multiplexing unit 108, the bit reservoir 106, and the channel bit reservoirs 107 are also the same as those in the first embodiment illustrated in FIG. 1.

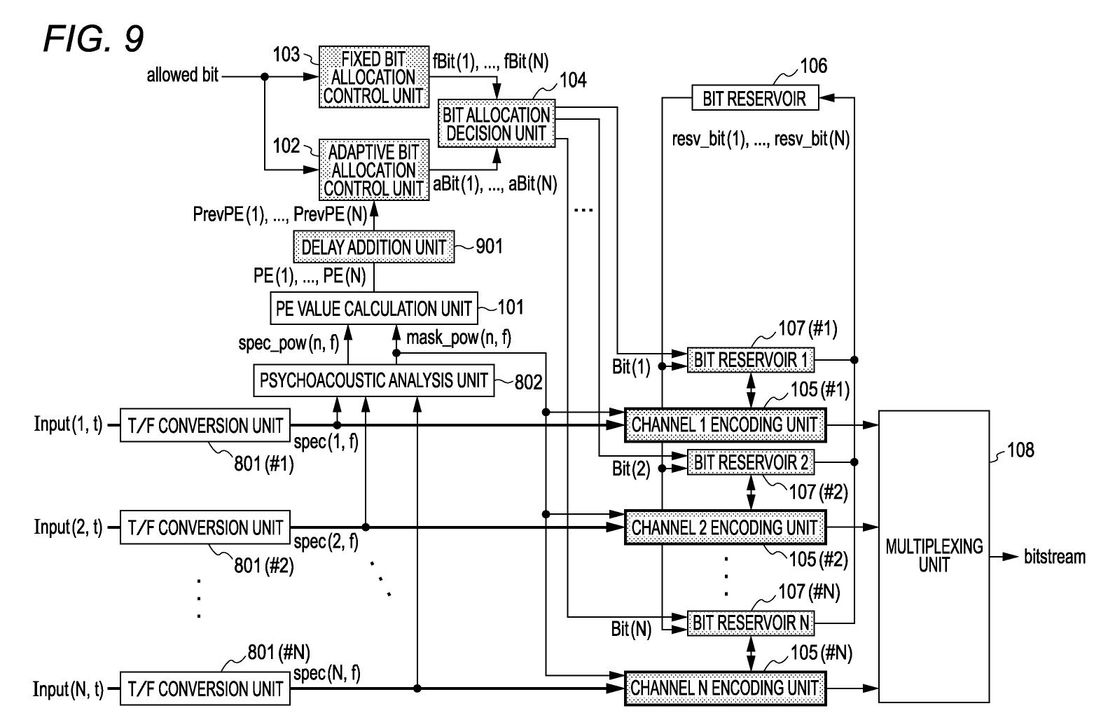

FIG. 9 is a schematic diagram of a third embodiment. This configuration is another embodiment based on that of the second embodiment illustrated in FIG. 8. In FIG. 9, the same number is attached to the same component as that in FIG. 1 or FIG. 8.

In the present embodiment, perceptual entropy values PE(1) to PE(N) of past frames obtained by delaying execution results for each channel of the T/F conversion units 801, the psychoacoustic analysis unit 802, and the PE value calculation unit 101 by a delay addition unit 901 in the current frame are input into the adaptive bit allocation control unit 102. As a result, there is an advantage that bit allocation of each channel can be decided in the bit allocation control operation of the current frame before each piece of processing by the T/F conversion units 801, the psychoacoustic analysis unit 802, and the PE value calculation unit 101 being performed. Accordingly, parallel processing of channels including the T/F conversion units 801, the psychoacoustic analysis unit 802, and the PE value calculation unit 101 can be performed so that an increase in load of encoding processing accompanying an increased number of channels can be distributed. Therefore, a configuration suitable for parallel processing using a plurality of CPUs can be realized.

Details of operations of the second and third embodiments (FIG. 8 and FIG. 9) will be described below. Incidentally, the second embodiment and the third embodiment are different only in that whether perceptual entropy values of past frames are used and therefore, the operation below is an operation common to the two embodiments.

First, the adaptive bit allocation control unit 102 in FIG. 8 or FIG. 9 calculates the number of adaptive bit allocation bits adaptive_bit from bits allowed in one frame allowed_bit and an adaptive/fixed allocation ratio AdFx_RATE (0.0 to 1.0).

adaptive_bit=AdFx_RATE×allowed_bit [formula 1]

Next, based on the formula 2 below, the adaptive bit allocation control unit 102 determines an adaptive allocation bit aBit (n) in accordance with the perceptual entropy value PE (n) of each channel using a result of the formula 1.

$$aBit ( n ) = adaptive\_bit \times PE ( n ) / PE\_Total \\ n = 1 , … , N \\ PE\_Total + {\sum }_{n = 1}^{N} PE ( n ) \qquad [ formula 2 ]$$

where PE_Total is a sum total of each PE (n) value of all channels. aBit (n) of each channel is a bit allocation value obtained by allocating adaptive bit allocation bits adaptive_bit in a ratio of PE (n) to PE_Total of each channel.

Next, the fixed bit allocation control unit 103 determines the number of fixed allocation bits fixed_bit based on the formula 3 below.

fixed bit=allowed bit−adaptive_bit [formula 3]

Further, the fixed bit allocation control unit 103 in FIG. 8 or FIG. 9 calculates fixed allocation bits fBit(n) of each channel from the formula 4 below using a preset fixed allocation ratio fix_RATE(n).

$$fBit ( n ) = fixed\_bit \times fix\_RATE ( n ) n = 1 , … , N \\ {\sum }_{n = 1}^{N} fix\_RATE ( n ) = 1.0 \qquad [ formula 4 ]$$

The sum total of all channels of fix_RATE(n) is 1. The fixed allocation ratio fix_RATE(n) may or may not be an equal allocation ratio, and different ratios among channels may be used. In the configuration of channel such as 5.1 channels, for example, channels arranged in front are important for human audition. In such a case, bit allocations fitting to human psychoacoustic characteristics are implemented by increasing the bit allocation ratio of front channels so that objective sound quality can be improved.

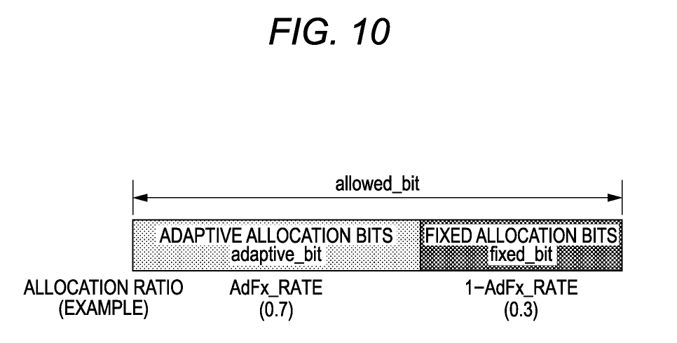

Relationships among the bits allowed in one frame allowed_bit, number of adaptive bit allocation bits adaptive_bit, number of fixed allocation bits fixed_bit, and adaptive/fixed allocation ratio AdFx_RATE are as illustrated in FIG. 10.

Next, the bit allocation decision unit 104 in FIG. 8 or FIG. 9 calculates a bit assignment Bit(n) for each channel by adding the adaptive allocation bits aBit(n) calculated by the adaptive bit allocation control unit 102 and the fixed allocation bits fBit(n) calculated by the fixed bit allocation control unit 103. That is, the bit assignment Bit(n) is calculated as shown by the formula 5 below.

Bit(n)=aBit(n)+fBit(n) n=1, . . . , N [formula 5]

Next, the bit reservoir 106 in FIG. 8 or FIG. 9 allocates reserve bits resv_bit_all stored in the bit reservoir 106 to a channel bit reservoir resv_bit (n) of each channel using a preset allocation ratio resv_RATE (n). That is, the reserve bits resv_bit_all are allocated as shown by the formula 6 below:

$$resv\_bit ( n ) = resv\_bit \_all \times resv\_RATE ( n ) \\ n = 1 , … , N \\ {\sum }_{n = 1}^{N} resv\_RATE ( n ) = 1.0 \qquad [ formula 6 ]$$

For the same reason as that for the fixed allocation ratio fix_RATE (n), the number of allocation bits may or may not use an equal allocation ratio, and may use different ratios among channels.

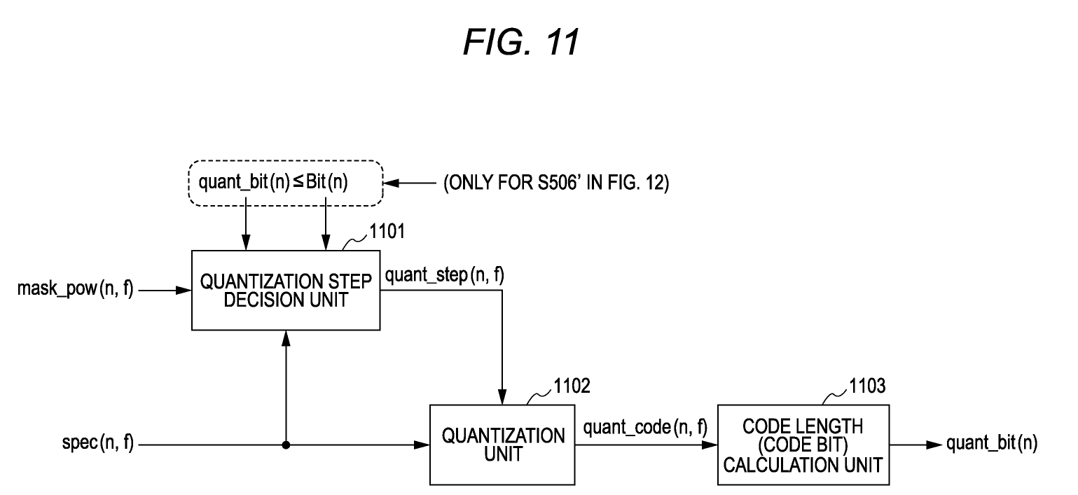

FIG. 11 is a diagram illustrating the configuration of the channel encoding unit 105 in FIG. 8 or FIG. 9. This configuration performs processing below independently in each channel n.

A quantization step decision unit 1101 decides a quantization step quant_step(n, f) of each band using the spectrum spec (n, f) obtained by the T/F conversion units 801 and the masking power mask_pow(n, f) obtained by the psychoacoustic analysis unit 802. That is, the quantization step quant_step (n, f) is decided as shown by the formula 7 below.

quant_step(n,f)=F(spec(n,f), mask_pow(n,f)) [formula 7]

where F( ) is any quantization step calculation function. This function calculates the quantization step quant_step(n,f) for each frequency such that quantization error power does not exceed the masking power mask_pow(n, f) when spec (n, f) is quantized.

Next, a quantization unit 1102 encodes the frequency spectrum spec (n, f) obtained by the T/F conversion units 801 based on the quantization step quant_step(n, f) of each band decided by the quantization step decision unit 1101. As a result, the quantization unit 1102 generates and outputs code data quant_code(n, f).

A code length (code bit) calculation unit 1103 calculates a total bit length quant_bit(n) (=number of encoding bits) of the code data quant_code(n, f) based on the formula 8 below.

$$quant\_bit ( n ) = {\sum }_{f = 1}^{F} = LEN ( quant\_code ( n , f ) ) \qquad [ formula 8 ]$$

where LEN( ) is a bit length calculation function of code data. The Huffman coding, for example, can be used as an encoding method.

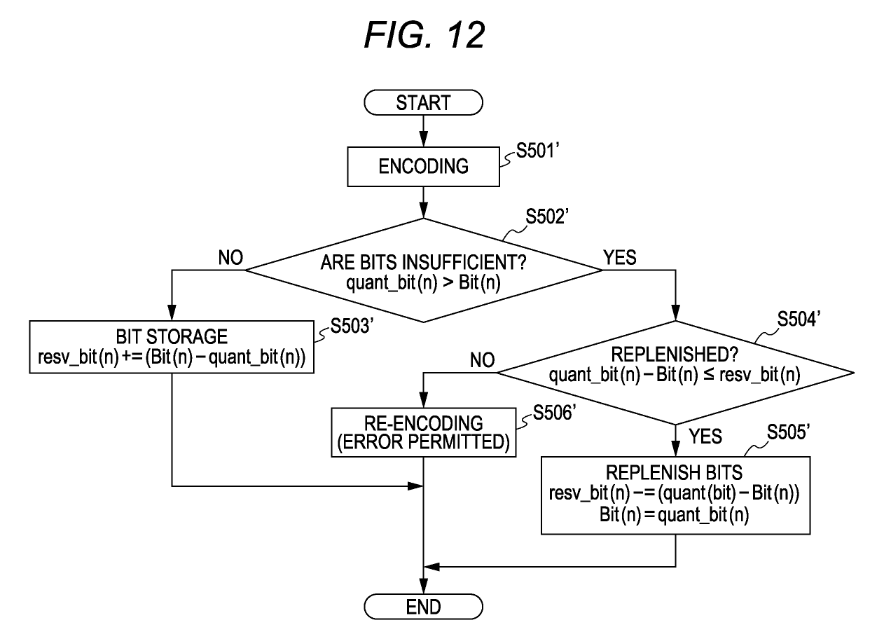

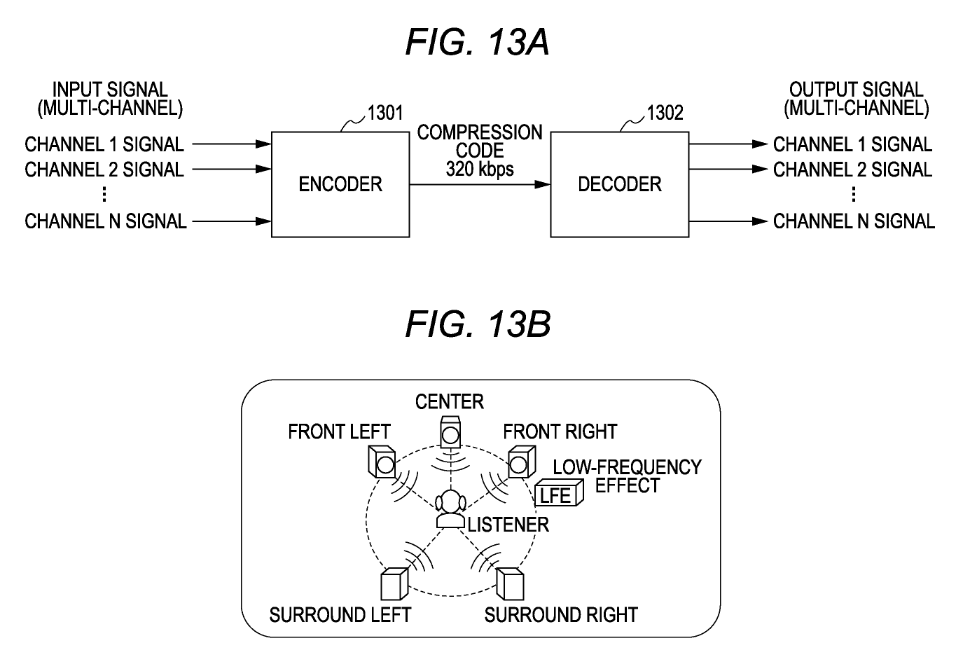

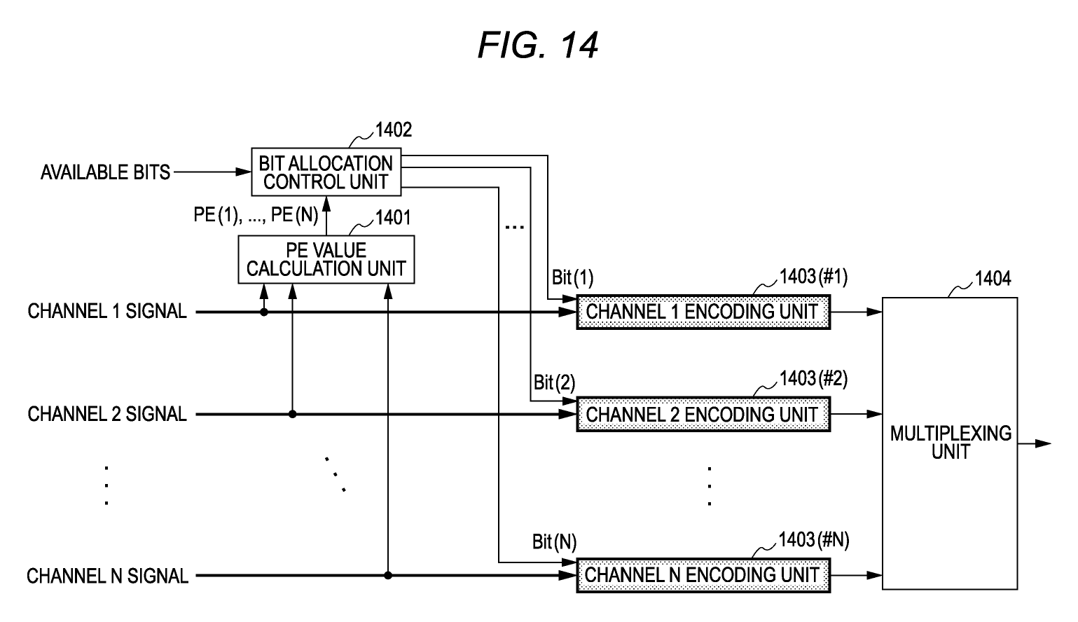

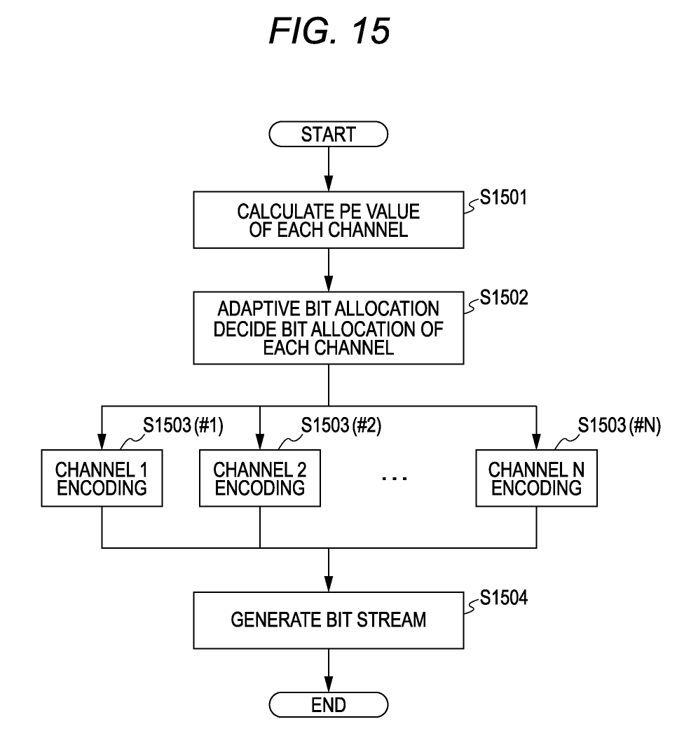

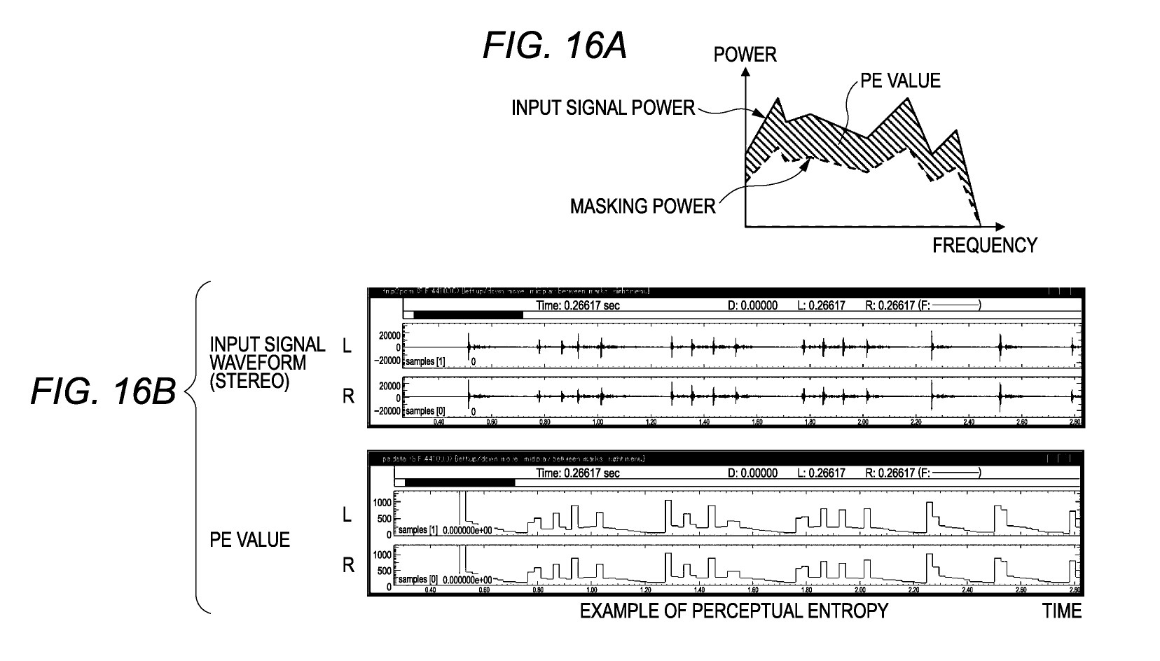

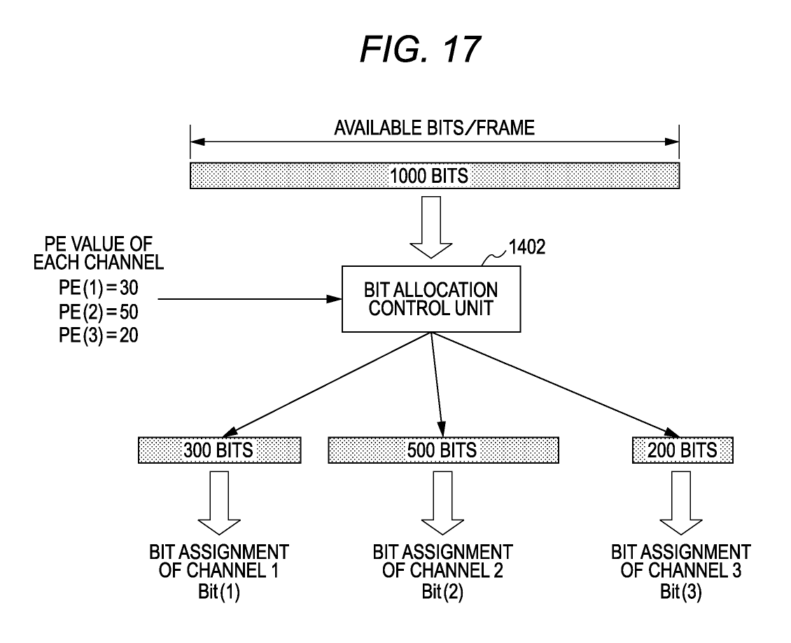

FIG. 12 is an operation flow chart showing the operation of bit replenishing control realized by the bit reservoir 106 and the channel bit reservoir 107 in FIG. 8 or FIG. 9. Step numbers excluding “′” in each step in FIG. 12 are the same as those illustrated in FIG. 5. That is, processing in each step of the operation flow chart in FIG. 12 represents processing in each step of the operation flow chart in FIG. 5 more concretely.

First, the #1 to #N channel bit reservoirs 107 instruct the #1 to #N channel encoding units 105 to perform encoding illustrated in FIG. 11, respectively (step S501′ in FIG. 12). As a result, the #1 to #N channel encoding units 105 encode each input signal of the Channel 1 signal to Channel N signal using the bit assignments Bit(1) to Bit(N) allocated by the bit allocation decision unit 104, respectively.

Next, the #1 to #N channel bit reservoirs 107 determine whether the number of bits quant_bit(n) necessary for encoding is larger than the assigned bits Bit(n) in the #1 to #N channel encoding units 105, respectively, that is, whether a bit shortage has occurred (step S502′ in FIG. 12).

The channel bit reservoir 107 in which no bit shortage occurs and whose determination at step S502′ is NO notifies excessive bits resv_bit(n)=Bit(n)−quant_bit(n) to the bit reservoir 106. As a result, the bit reservoir 106 adds the excessive bits resv_bit(n) to storage bits to terminate processing on the channel in the current frame (step S503′ in FIG. 12).

On the other hand, the channel bit reservoir 107 in which a bit shortage occurs and whose determination at step S502′ is YES determines whether insufficient bits can be replenished. That is, the channel bit reservoir 107 determines whether (quant_bit(n)−Bit(n)) is equal to or less than storage bits resv_bit (n) of the channel bit reservoir 107 (step S504′ in FIG. 12).

If bits can be replenished and the determination of the channel bit reservoir 107 at step S504′ is YES, assigned bits of the channel bit reservoir 107 are set to quant_bit(n). At the same time, replenished bits (quant_bit(n)−Bit(n)) are subtracted from storage bits resv_bit(n) to set the new value as new storage bits resv_bit(n) of the channel (step S505′ in FIG. 12).

On the other hand, if bits cannot be replenished and the determination at step S504′ is NO, processing shown below is performed on the quantization step decision unit 1101 (FIG. 11) in the channel encoding unit 105 corresponding to the channel bit reservoir 107. That is, the number of quantization steps quant_step(n, f) is changed in such a way that necessary bits quant_bit(n) that become necessary as a result of quantization is equal to or less than assigned bits Bit(n) (step S506′ in FIG. 12). Accordingly, encoding is performed again by the quantization unit 1102 in FIG. 11.

Lastly, as shown by the formula 9 below, the bit reservoir 106 calculates the sum total resv_bit_all of storage bits resv_bit (n) of each of the channel bit reservoirs 107 and stores the sum total resv_bit_all in the bit reservoir 106 for the next frame.

$$resv\_bit \_all = {\sum }_{n = 1}^{N} resv\_bit ( n ) \qquad [ formula 9 ]$$

Thus, when compared with the conventional adaptive bit allocation based on the perceptual entropy value only, optimal bit allocation for a multi-channel input signal can be achieved while suppressing bit shortages caused by an estimation error so that stable sound quality can be realized.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1. An audio encoding apparatus that encodes audio signals of a plurality of channels, comprising:
an adaptive bit allocation control unit that adaptively controls a variable number of encoding bits assigned to the audio signal of each channel in accordance with perceptual entropy of the audio signal of each of the channels;
a fixed bit allocation control unit that fixedly controls a fixed number of encoding bits assigned to the audio signal of each of the channels in predetermined allocations; and
a channel encoding unit that encodes the audio signal of each of the channels based on the variable number of encoding bits assigned by the adaptive bit allocation control unit and the fixed number of encoding bits assigned by the fixed bit allocation control unit.

2. The audio encoding apparatus according to claim 1, further comprising:
a bit reservoir unit that, when a needed number of encoding bits necessary for encoding is smaller than a total number of encoding bits assigned to the channel encoding unit, stores a number of excessive bits corresponding to a difference thereof and, when the total number of encoding bits assigned to the channel encoding unit is smaller than the needed number of bits necessary for the encoding, assigns the number of the excessive bits.

3. The audio encoding apparatus according to claim 1, wherein
the fixed bit allocation control unit decides allocation of the fixed number of encoding bits assigned to the audio signal of each of the channels based on psychoacoustic weights of channel arrangement of each of the channels.

4. The audio encoding apparatus according to claim 1, wherein
the adaptive bit allocation control unit adaptively controls the variable number of encoding bits assigned to the audio signal of each of the channels in a current frame in accordance with the perceptual entropy calculated for past frames of the audio signal of each of the channels.

5. A method for an audio encoding apparatus that encodes audio signals of a plurality of channels, said method comprising:
adaptively controlling a variable number of encoding bits assigned to the audio signal of each channel in accordance with perceptual entropy of the audio signal of each of the channels;
fixedly controlling a fixed number of encoding bits assigned to the audio signal of each of the channels in predetermined allocations; and
encoding the audio signal of each of the channels based on the variable number of encoding bits assigned by the adaptive bit allocation control step and the fixed number of encoding bits assigned by the fixed bit allocation control step.

6. The audio encoding method according to claim 5, further comprising:
when a needed number of encoding bits necessary for encoding is smaller than a total number of encoding bits assigned to the channel encoding step, storing a number of excessive bits corresponding to a difference thereof and, when the total number of encoding bits assigned to the channel encoding step is smaller than the needed number of bits necessary for the encoding, assigning the number of the excessive bits.
